(19) United States
(12) Patent Application Publication
(10) Pub. No.: US 2012/0060101 A1
(43) Pub. Date: Mar. 8, 2012

(54) METHOD AND SYSTEM FOR AN INTERACTIVE EVENT EXPERIENCE

(75) Inventors: Stanislav Vonog, San Francisco, CA (US); Nikolay Surin, San Francisco, CA (US); Tara Lemmey, San Francisco, CA (US)

(73) Assignee: Net Power and Light, Inc., San Francisco, CA (US)

(21) Appl. No.: 13/221,801

(22) Filed: Aug. 30, 2011

Related U.S. Application Data
(60) Provisional application No. 61/378,285, filed on Aug. 30, 2010.

(51) Int. Cl. G06F 3/01

(52) U.S. Cl. 715/751

(57) ABSTRACT

The present invention contemplates an interactive event experience capable of coupling and strategically synchronizing multiple (and varying) venues, with live events happening at one or more venues. For example, the system equalizes between local participants and remote ones, and between local shared screens and remote ones—thus making experience of events synchronized. In one event, a host participant creates and initiates the event, which involves inviting participants from the host participant's social network, and programming the event either by selecting a predefined event or defining the specific aspects of an event. In one specific instance, and event may have: a first layer with live audio and video dimensions; a video chat layer with interactive, graphics and ensemble dimensions; a Group Rating layer with interactive, ensemble, and i/o commands dimensions; a panoramic layer with 360 pan and i/o commands dimensions; an ad/gaming layer with game mechanics, interaction, and i/o commands dimensions; and a chat layer with interactive and ensemble dimensions. In addition to aspects of the primary portion of the event experience, the event can have pre-event and post-event activities.

### BACKGROUND OF INVENTION

1. Field of Invention

The present teaching considers an interactive event experience capable of coupling and strategically synchronizing multiple (and varying) venues, with live events happening at one or more venues.

2. Description of Related Art

The current state of live entertainment limits audience participation and is mostly constrained to one physical venue combined with broadcasting over satellite to TVs/set-top boxes where the event/experience is watched passively. Participation is never real time—at best you can vote by text messaging or calling in.

While live Internet broadcasts are evolving, interaction options are still limited. Internet users can text with each other, view statistics and information (in the case of a sporting event). Internet experiences are frequently limited to one screen.

Advanced live broadcast organizers (such as TED Conference) include multiple venues: such as the main TED venue in Long Beach, secondary venue (e.g. Aspen) and many private venues (people's homes who organize TED viewing parties). The participants watch the same live HD video stream. From time to time conference host in main venue interacts with audience in remote venues (e.g. say hello, show remote audience, and ask questions). The audiences feel connected during those brief moments but otherwise it is a disconnected experience somewhat like watching a TV broadcast.

New York Metropolitan Opera broadcasts opera performances live in HD thus extending the audience beyond the opera house. Participation requires buying a ticket to join the live broadcast or an ongoing subscription. Interaction options are limited. People in the Opera House don't feel connected to other participants; while the online viewers see the audience in the opera house, it's still largely a passive watching experience.

In a stadium people are entertained by trivia games displayed on a “jumbotron,” e.g., cameras can pick out people from the audience and show them on the screen. In some cases people can send text messages to stadium screens, pictures, participate in voting or trivia games through text messaging. This makes people feel more connected in the same venue but the interactions are limited, controlled by the show organizers

Music concerts involve many displays and sound systems—synchronized to provide audiovisual background for a better experience. Fans stand side by side, frequently can sing and dance together—feeling connected to each other. The concerts are frequently broadcast live to large audiences using satellite systems and—sometimes—Internet. Robbie Williams' concerts have been involving simulcasts. Quote: “The Guinness World Records confirmed [in 2009] BBC Worldwide's live show of Williams' concert, shown via satellite in venues in 23 countries, marked the most simultaneous cinematic screenings of a live concert in history.” http://www.chartattack.com/news/75884/robbie-williams-breaks-concert-simulcast-world-record

Again—while satisfying to many fans in all these countries—the experience is passive and disconnected.

### SUMMARY OF THE INVENTION

The present invention contemplates a variety of methods and systems supporting live entertainment and other events—providing a plethora of options for in-venue activities while connecting venues, audiences and individuals more deeply and more intimately. One specific embodiment discloses an interactive event experience capable of coupling and strategically synchronizing multiple (and varying) venues, with live events happening at one or more venues.

Certain systems and methods provide an interactive event experience with various dimensions and aspects, such as multi-dimensional layers described in more detail below. In one specific instantiation, a host participant creates and initiates an event, which involves inviting participants from the host participant's social network, and programming the event either by selecting a predefined event or defining the specific aspects of an event. In certain cases, an event may have: a first layer with live audio and video dimensions; a video chat layer with interactive, graphics and ensemble dimensions; a Group Rating layer with interactive, ensemble, and i/o commands dimensions; a panoramic layer with 360 pan and i/o commands dimensions; an ad/gaming layer with game mechanics, interaction, and i/o commands dimensions; and a chat layer with interactive and ensemble dimensions. In addition to aspects of the primary portion of the event experience, the event can have pre-event and post-event activities.

According to one aspect, the system would allow live interaction from all participants and would also allow people to host and join private events (not only large ones). In another aspect, the system deals with large amounts of continuous input streams, decoupling input from processing, generating and rendering outputs. The inputs are recombined. In another aspect, synchronicity between various venues is carefully orchestrated.

Another aspect of the present teaching allows people to be connected live:
in the same physical venue;
can join from other public venue
can join with multiple people from home (create own private venue and “attach” the venue to the live event)
can join individually
can join from “coming to the event” state—>such as shuttle coming to stadium, or a car, or public transport

Participants in all types of venues are continuously participating in activities that involve interaction with each other and shared screens (more generally—output devices). In other embodiments, activities change based on event stage, e.g., pre-event, main event, break during main event (need to add to a diagram), and/or post-event. In other embodiments, activities may be presented differently based on venue type, location and output device. According to further embodiments, activities may be presented differently to each person/or on shared venue screens based on social data about participants. The event may have a variety of hosts/directors/curators—based on venues—making it more personalized.

In certain embodiments, activities take advantage of all available output such as screens and audio—synchronously. In other embodiments, activities can take advantage of locally available and remote computing capacity.

In other embodiments, participants people can be joined in groups and act as part of groups (team activities), and in certain cases groups may be rearranged.

According to the present teaching, activities are not hard-wired into the system. In certain embodiments, only simple hardware and generic software agents are required on people's devices and devices attached to shared screens etc. By decoupling inputs from processing from rendering from output the system seamlessly integrates and synchronizes the distributed environments.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a system architecture for composing and directing user experiences;

FIG. 2 is a block diagram of an experience agent;

FIG. 3 is a block diagram of a sentio codec;

FIG. 4 is a flow chart illustrating a method for creating and directing an interactive social event experience;

FIGS. 5-12 illustrate some aspects of a specific interactive social event experience;

FIG. 13 is a block diagram of an example event configuration with multiple and various venues;

FIG. 14 depicts an example computing environment corresponding to an example event configuration;

FIG. 15 depicts an example venue;

FIG. 16 illustrates a prior art composite screen;

FIG. 17 illustrates a composite shared screen paradigm according to one aspect;

FIG. 18 is a block diagram of a computing device;

FIG. 19 illustrates a computing architecture.

### DETAILED DESCRIPTION OF THE INVENTION

The present invention contemplates an interactive event experience capable of coupling and strategically synchronizing multiple (and varying) venues, with live events happening at one or more venues. For example, the system equalizes between local participants and remote ones, and between local shared screens and remote ones—thus making experience of events synchronized. As will be appreciated, the following figures and descriptions are intended as suitable example and implementations and are not intended to be limiting.

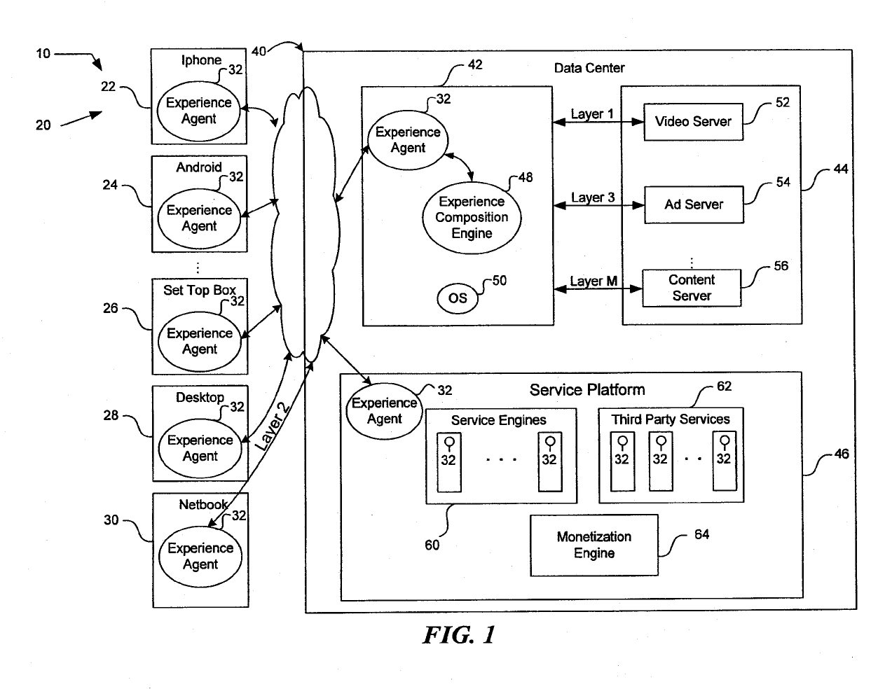

FIG. 1 illustrates a block diagram of an experience system 10. The system 10 can be viewed as an “experience platform” or system architecture for composing and directing a participant experience. In one embodiment, the experience platform 10 is provided by a service provider to enable an experience provider to compose and direct a participant experience. The participant experience can involve one or more experience participants. In certain embodiments, a specific experience participant (a “host participant”) is enabled by the experience provider to create and initiate an interactive social event experience. The experience provider can provide an experience with a variety of dimensions, as will be explained further now. As will be appreciated, the following description provides one paradigm for understanding the multi-dimensional experience available to the participants. There are many suitable ways of describing, characterizing and implementing the experience platform contemplated herein.

In one embodiment, services are defined at an API layer of the experience platform. The services can be categorized into “dimensions.” The dimension(s) can be recombined into “layers.” The layers form to make features in the experience.

By way of example, the following are some of the dimensions that can be supported on the experience platform.

Video—is the near or substantially real-time streaming of the video portion of a video or film with near real-time display and interaction.

Audio—is the near or substantially real-time streaming of the audio portion of a video, film, karaoke track, song, with near real-time sound and interaction.

Live—is live display and/or access to a live video, film, or audio stream in near real-time that can be controlled by another experience dimension. A live display is not limited to single data stream.

Encore—is the replaying of a live video, film or audio content. This replaying can be the raw version as it was originally experienced, or some type of augmented version that has been edited, remixed, etc.

Graphics—is a display that contains graphic elements such as text, illustration, photos, freehand geometry and the attributes (size, color, and location) associated with these elements. Graphics can be created and controlled using the experience input/output command dimension(s) (see below).

Input/Output Command(s)—are the ability to control the video, audio, picture, display, sound or interactions with human or device-based controls. Some examples of input/output commands include physical gestures or movements, voice/sound recognition, and keyboard or smart-phone device input(s).

Interaction—is how devices and participants interchange and respond with each other and with the content (user experience, video, graphics, audio, images, etc.) displayed in an experience. Interaction can include the defined behavior of an artifact or system and the responses provided to the user and/or player.

Game Mechanics—are rule-based system(s) that facilitate and encourage players to explore the properties of an experience space and other participants through the use of feedback mechanisms. Some services on the experience Platform that could support the game mechanics dimensions include leader boards, polling, like/dislike, featured players, star-ratings, bidding, rewarding, role-playing, problem-solving, etc.

Ensemble—is the interaction of several separate but often related parts of video, song, picture, story line, players, etc. that when woven together create a more engaging and immersive experience than if experienced in isolation.

Auto Tune—is the near real-time correction of pitch in vocal and/or instrumental performances. Auto Tune is used to disguise off-key inaccuracies and mistakes, and allows singer/players to hear back perfectly tuned vocal tracks without the need of singing in tune.

Auto Filter—is the near real-time augmentation of vocal and/or instrumental performances. Types of augmentation could include speeding up or slowing down the playback, increasing/decreasing the volume or pitch, or applying a celebrity-style filter to an audio track (like a Lady Gaga or Heavy-Metal filter).

Remix—is the near real-time creation of an alternative version of a song, track, video, image, etc. made from an original version or multiple original versions of songs, tracks, videos, images, etc.

Viewing 360°/Panning—is the near real-time viewing of the 360° horizontal movement of a streaming video feed on a fixed axis. Also the ability to for the player(s) to control and/or display alternative video or camera feeds from any point designated on this fixed axis.

Turning back to FIG. 1, the experience platform 10 includes a plurality of devices 20 and a data center 40. The devices 12 may include devices such as an iPhone 22, an android 24, a set top box 26, a desktop computer 28, and a netbook 30. At least some of the devices 12 may be located in proximity with each other and coupled via a wireless network. In certain embodiments, a participant utilizes multiple devices 12 to enjoy a heterogeneous experience, such as using the iPhone 22 to control operation of the other devices. Multiple participants may also share devices at one location, or the devices may be distributed across various locations for different participants.

Each device 12 has an experience agent 32. The experience agent 32 includes a sentio codec and an API. The sentio codec and the API enable the experience agent 32 to communicate with and request services of the components of the data center 40. The experience agent 32 facilitates direct interaction between other local devices. Because of the multi-dimensional aspect of the experience, the sentio codec and API are required to fully enable the desired experience. However, the functionality of the experience agent 32 is typically tailored to the needs and capabilities of the specific device 12 on which the experience agent 32 is instantiated. In some embodiments, services implementing experience dimensions are implemented in a distributed manner across the devices 12 and the data center 40. In other embodiments, the devices 12 have a very thin experience agent 32 with little functionality beyond a minimum API and sentio codec, and the bulk of the services and thus composition and direction of the experience are implemented within the data center 40.

Data center 40 includes an experience server 42, a plurality of content servers 44, and a service platform 46. As will be appreciated, data center 40 can be hosted in a distributed manner in the “cloud,” and typically the elements of the data center 40 are coupled via a low latency network. The experience server 42, servers 44, and service platform 46 can be implemented on a single computer system, or more likely distributed across a variety of computer systems, and at various locations.

The experience server 42 includes at least one experience agent 32, an experience composition engine 48, and an operating system 50. In one embodiment, the experience composition engine 48 is defined and controlled by the experience provider to compose and direct the experience for one or more participants utilizing devices 12. Direction and composition is accomplished, in part, by merging various content layers and other elements into dimensions generated from a variety of sources such as the service provider 42, the devices 12, the content servers 44, and/or the service platform 46.

The content servers 44 may include a video server 52, an ad server 54, and a generic content server 56. Any content suitable for encoding by an experience agent can be included as an experience layer. These include well know forms such as video, audio, graphics, and text. As described in more detail earlier and below, other forms of content such as gestures, emotions, temperature, proximity, etc., are contemplated for encoding and inclusion in the experience via a sentio codec, and are suitable for creating dimensions and features of the experience.

The service platform 46 includes at least one experience agent 32, a plurality of service engines 60, third party service engines 62, and a monetization engine 64. In some embodiments, each service engine 60 or 62 has a unique, corresponding experience agent. In other embodiments, a single experience 32 can support multiple service engines 60 or 62. The service engines and the monetization engines 64 can be instantiated on one server, or can be distributed across multiple servers. The service engines 60 correspond to engines generated by the service provider and can provide services such as audio remixing, gesture recognition, and other services referred to in the context of dimensions above, etc. Third party service engines 62 are services included in the service platform 46 by other parties. The service platform 46 may have the third-party service engines instantiated directly therein, or within the service platform 46 these may correspond to proxies which in turn make calls to servers under control of the third-parties.

Monetization of the service platform 46 can be accomplished in a variety of manners. For example, the monetization engine 64 may determine how and when to charge the experience provider for use of the services, as well as tracking for payment to third-parties for use of services from the third-party service engines 62.

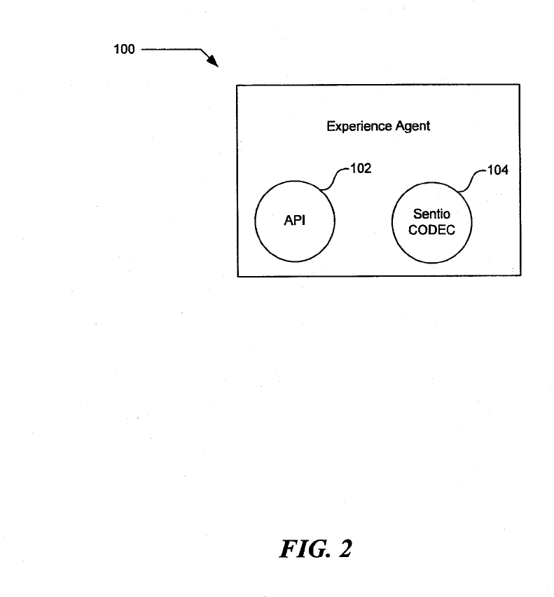

FIG. 2 illustrates a block diagram of an experience agent 100. The experience agent 100 includes an application programming interface (API) 102 and a sentio codec 104. The API 102 is an interface which defines available services, and enables the different agents to communicate with one another and request services.

The sentio codec 104 is a combination of hardware and/or software which enables encoding of many types of data streams for operations such as transmission and storage, and decoding for operations such as playback and editing. These data streams can include standard data such as video and audio. Additionally, the data can include graphics, sensor data, gesture data, and emotion data. (“Sentio” is Latin roughly corresponding to perception or to perceive with one's senses, hence the nomenclature “sensio codec.”)

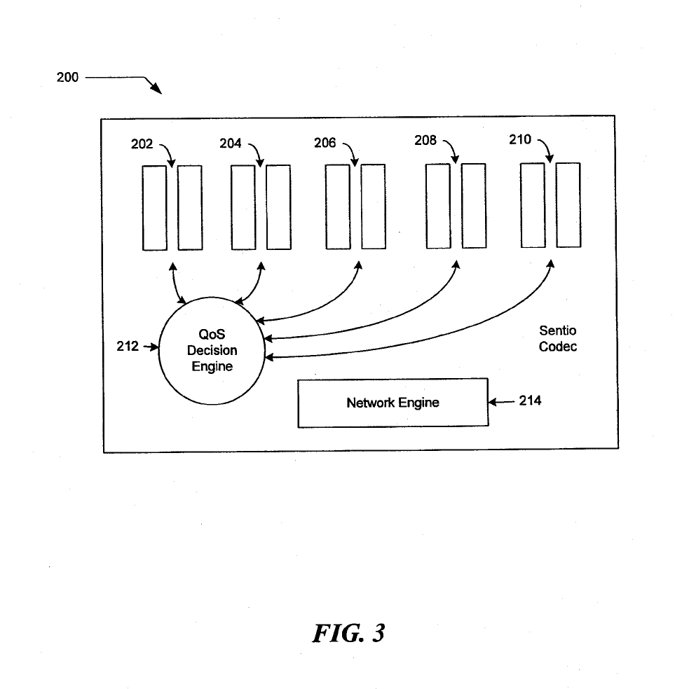

FIG. 3 illustrates a block diagram of a sentio codec 200. The sentio codec 200 includes a plurality of codecs such as video codecs 202, audio codecs 204, graphic language codecs 206, sensor data codecs 208, and emotion codecs 210. The sentio codec 200 further includes a quality of service (QoS) decision engine 212 and a network engine 214. The codecs, the QoS decision engine 212, and the network engine 214 work together to encode one or more data streams and transmit the encoded data according to a low-latency transfer protocol supporting the various encoded data types. One example of this low-latency protocol is described in more detail in Vonog et al.'s U.S. patent application Ser. No. 12/569,876, filed Sep. 29, 2009, and incorporated herein by reference for all purposes including the low-latency protocol and related features such as the network engine and network stack arrangement.

The sentio codec 200 can be designed to take all aspects of the experience platform into consideration when executing the transfer protocol. The parameters and aspects include available network bandwidth, transmission device characteristics and receiving device characteristics. Additionally, the sentio codec 200 can be implemented to be responsive to commands from an experience composition engine or other outside entity to determine how to prioritize data for transmission. In many applications, because of human response, audio is the most important component of an experience data stream. However, a specific application may desire to emphasize video or gesture commands.

The sentio codec provides the capability of encoding data streams corresponding with many different senses or dimensions of an experience. For example, a device 12 may include a video camera capturing video images and audio from a participant. The user image and audio data may be encoded and transmitted directly or, perhaps after some intermediate processing, via the experience composition engine 48, to the service platform 46 where one or a combination of the service engines can analyze the data stream to make a determination about an emotion of the participant. This emotion can then be encoded by the sentio codec and transmitted to the experience composition engine 48, which in turn can incorporate this into a dimension of the experience. Similarly a participant gesture can be captured as a data stream, e.g. by a motion sensor or a camera on device 12, and then transmitted to the service platform 46, where the gesture can be interpreted, and transmitted to the experience composition engine 48 or directly back to one or more devices 12 for incorporation into a dimension of the experience.

FIGS. 1-3 above directly address one possible architect supporting experiences; the support includes creating and directing experiences. The above description spoke of experiences in a general manner. As will be appreciated, a variety of experience types or genres can be implemented on the experience platform. One genre is an interactive, multi-participant event experience created and initiated by a host participant, the experience including content, social and interactive layers.

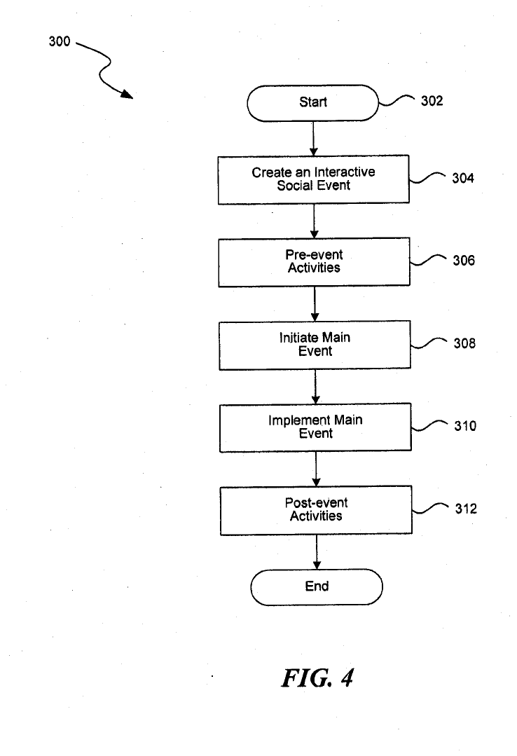

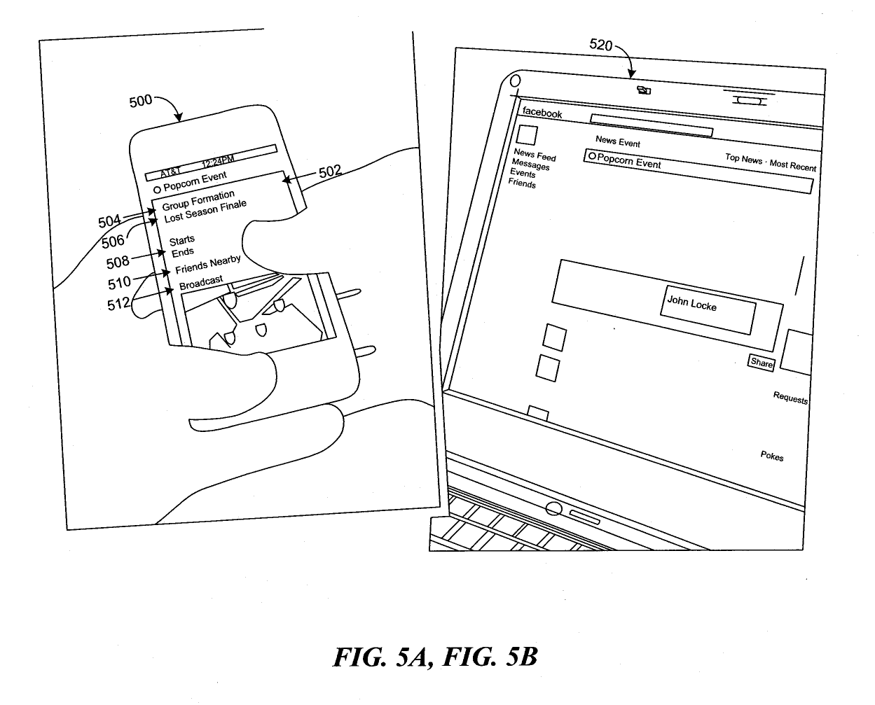

FIGS. 4-12 will now be used to describe certain aspects of a host participant created event, as well as one specific event of this genre. FIG. 4 is a flow chart illustrating certain acts involved in one generic host participant created event. FIGS. 5-12 illustrate different aspects of an instantiation of a specific event, namely, a “Lost” experience where the base content layer is the season finale of the hit television show “Lost.”

FIG. 4 shows a method 300 for providing an interactive social event experience with layers. The interactive social event method 300 begins in a step 302. Step 302 brings us to the point where a host participant may create and initiate an event.

The method 300 continues in a step 304 where a host participant creates the interactive social event. In the Lost event, the host participant engages with an interface to create the event. FIG. 5a specifically shows a handheld device 500 showing an interface 502 providing options for “Group Formation” 504, defined content layer 506, time window 508, Friends Nearby 510, and Broadcast 512. The interface 502 is one suitable interface for the host participant to create the event on a handheld device 500 such as an iPhone.

In certain embodiments, the device utilized by the host participant and the server providing the event creation interface each have an experience agent. Thus the interface can be made up of layers, and the step of creating the event can be viewed as one experience. Alternatively, the event can be created through an interface where neither device nor server has an experience agent, and/or neither utilizes an experience platform.

The interface and underlying mechanism enabling the host participant to create and initiate the event can be provided through a variety of means. For example, the interface can be provided by a content provider to encourage consumers to access the content. The content provider could be a broadcasting company such as NBC, an entertainment company like Disney, etc. The interface could also be provided by an aggregator of content, like Netflix, to promote and facilitate use of its services. Alternatively, the interface could be provided by an experience provider sponsoring an event, or an experience provider that facilitates events in order to monetize such events.

In any event, the step 304 of creating the interactive social event will typically include identifying participants from the host participant's social group to invite (“group formation”), and programming the dimensions and/or layers of the interactive social event. Programming may mean simply selecting a pre-programmed event with set layers defined by the experience provider, e.g., by a television broadcasting company offering the event.

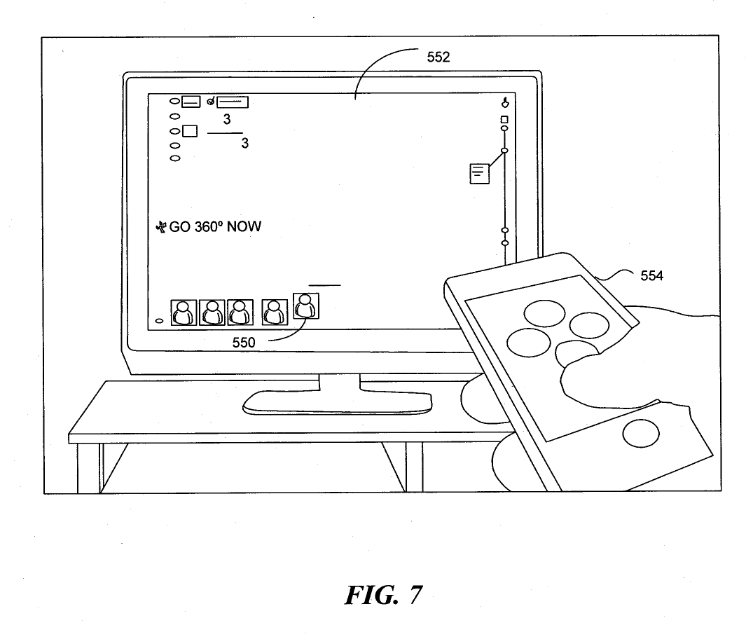

Turning back to FIG. 4, now that the event has been created, the host participant initiates any pre-event activities in step 306. The “main event” shown in FIGS. 7-10 begins with participants joining the live event and having an interactive social experience surrounding the Lost content and other layers described above. However, social interactive events begin prior to the main event, e.g., with the act of inviting the various participants. For example, FIG. 5b illustrates a portable personal computer 520 where an invited participant receives an invitation or notification of the specific interactive event created by the host participant of FIG. 5a.

The pre-event activities may involve a host of additional aspects. These range from sending event reminders and/or teasers, acting to monetize the event, authorizing and verifying participants, distributing ads, providing useful content to participants (e.g., previous Lost episodes), implementing pre-event contests, surveys, etc., among participants. For example, the participants could be given the option of inviting additional participants from their social networks. Or perhaps the layers generated during the event, or the sponsors of the event, could depend on known characteristics of the participants, or the participants response to a pre-event survey, etc.

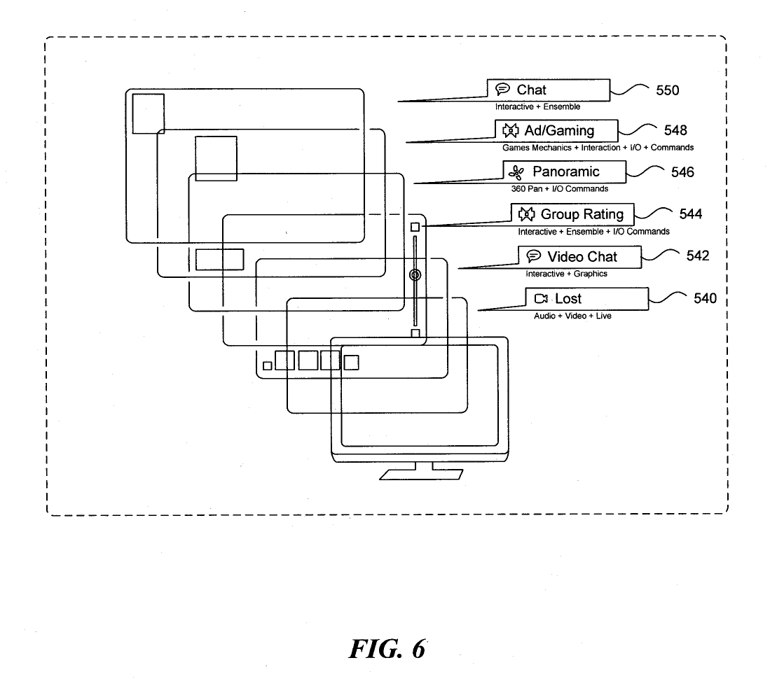

In a step 308, the host participant initiates the main event, and in a step 310, the experience provider in real time composes and directs the event based on the host participant's creation and other factors. FIG. 6 illustrates some possible layers of the Lost event introduced in FIGS. 5a and 5b. Here a first layer 540 provides live audio and video dimensions corresponding to an episode of the television show “Lost” as the base content layer. A video chat layer 542 provides interactive, graphics and ensemble dimensions. A Group Rating layer 544 provides interactive, ensemble, and i/o commands dimensions. A panoramic layer 546 provides 360 panning and i/o commands dimensions. An ad/gaming layer 548 provides game mechanics, interaction, and i/o commands dimensions. A chat layer 550 provides interactive and ensemble dimensions.

FIGS. 7-10 illustrate the Lost event as it is happening across several different geographic locations. In each of these locations, different participants are experiencing the Lost event utilizing a variety of different devices. As can be seen, the participants are each utilizing different sets of layers, either through choice, or perhaps as necessitated by the functionality of the available devices.

FIG. 7 illustrates utilization of the group video ensemble. In this case, video streams are received from multiple participants and are remixed as a layer on top of the Lost base content layer. The video layers received from the participants can be remixed on a server, or the remixing can be accomplished locally through a peer-to-peer process. For example, if the participants are many and the network capabilities sufficient, the remixing may be better accomplished at a remote server. If the number of participants is small, and/or all participants are local, the video remixing may be better accomplished locally, distributed among the capable devices.

FIG. 7 further provides a layer with “highlighting/outlining” dimensions. For example, one participant 550 has drawn a circle 552 around an actor to highlight the actor and deliver some relevant point. The circle 550 could be drawn with a device 554 using touch on an iPad or an iPhone, or a mouse, etc. The layer containing the circle and point is merged in real-time with the Lost base layer so that all participants can view this layer.

With still further reference to FIG. 7, a mobile device such an iPhone can be used to add physicality to the experience similar to Wii's motion-sensing controller. In certain embodiments, experience events are enhanced through gestures and movements sensed by the mobile device that help participants evoke emotion. E.g., an iPhone can be used by a participant to simulate throwing tomatoes on screen. Another example is applause—you can literally clap on your iPhone using a clap gesture. The mobile device typically has some kind of motion-sensing capability such as built-in accelerometers, gyroscopes, or IR-assisted (infrared cameras) motion sensing, video cameras, etc. Microphone and video camera input can be used to enhance the experience. As will be appreciated, there are a variety of gestures suitable for enhancing the event experience. More of these gestures are described in Lemmey et al.'s provisional patent application No. 61/373,339, filed Aug. 13, 2010, and entitled “Method and System for Device Interaction Through Gestures,” the contents of which are incorporated herein by reference.

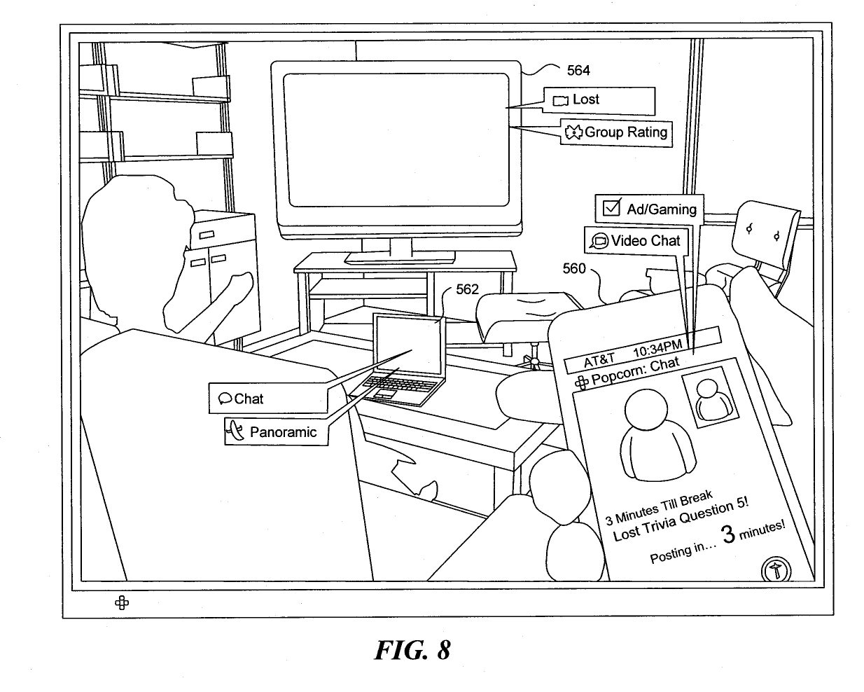

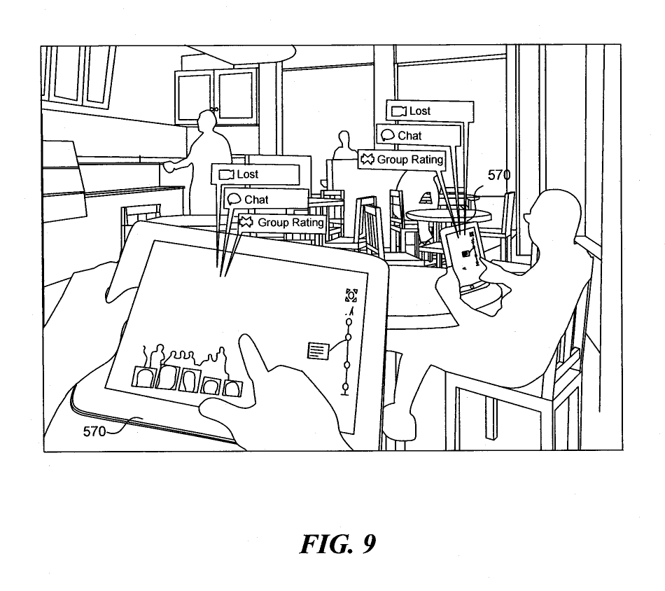

FIGS. 8-9 illustrate, among other aspects, which different sets of layers can go to different devices depending upon the participants' desire and the capability of the different devices. FIG. 8 shows a portable device 560 with an ad/gaming layer and a video chat layer, a laptop computer 562 with a chat layer and a panoramic layer, and a display screen (TV, dummy terminal, etc.) 564 with the Lost base layer and the Group Rating Layer. Further, participants can engage in the experience using multiple devices and sharing at least one device, e.g., the participants associated with the portable device 560 and the laptop computer 562 each have visual access to and share the display 564. In an alternative embodiment shown in FIG. 9, each participant has their own portable device 570 with multiple layers demonstrating that participants can engage in the event experience using a single device such as an iPad remotely (w/o TV or multi-device setup).

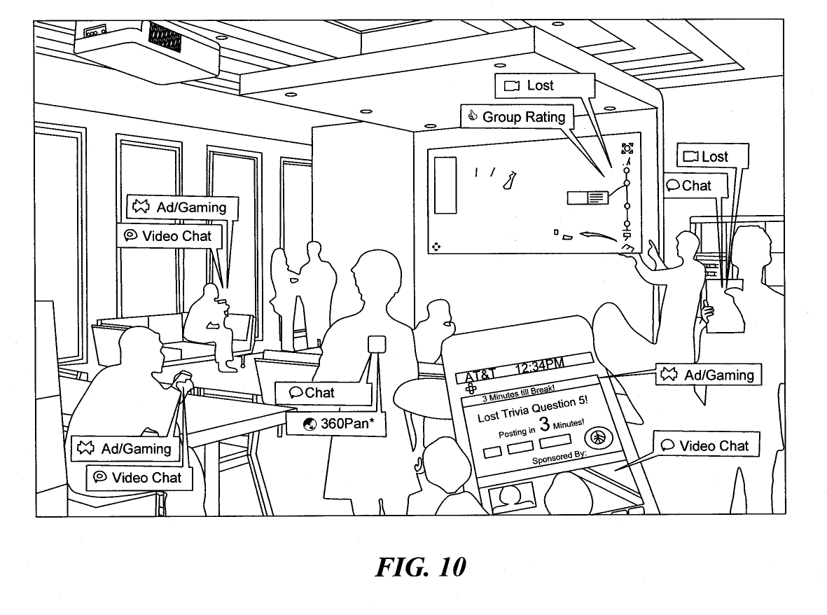

FIG. 10 illustrates a group a group of participants interacting locally with each other, in addition to two other groups in NY and Chicago. This demonstrates ensemble activity with multiple roles, e.g., one participant is a quiz director setting up and directing a quiz, and the participants are participating in game mechanics specifically within this local group. Some layers are generated in a peer-to-peer fashion locally, not going to the server which serves all participant groups, and in fact these layers may not be remixed and sent to remote groups, but could be experienced only locally.

The example of FIG. 10 illustrates how the teachings found herein can provide a participatory entertainment experience around a TV show or programming such as live sports. No human resources on the base content provider's side are required to create engaging overlays—they are participant generated in real-time. The example highlights the value of layers, ensemble, physicality, group formation, and pre-post event activities.

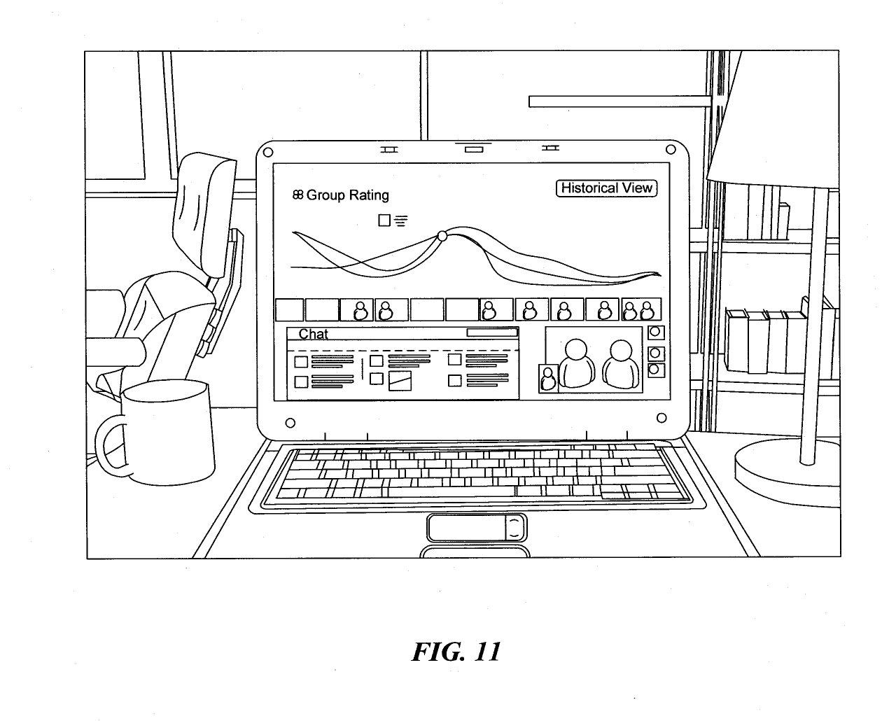

A step 312 implements post-event activities. As will be appreciated, a variety of different post-event activities can be provided. For example, FIG. 11 illustrates an interface for a participant to interact with a historical view of the interactive social event. This may include a layer providing interactive charting of the group rating during the event. Another layer may provide an interactive review window of the chat layer, and yet another layer could provide an interactive review window of the video chat. These post-event activities could be engaged in independently by participants, or could involve additional ensemble interactive dimensions.

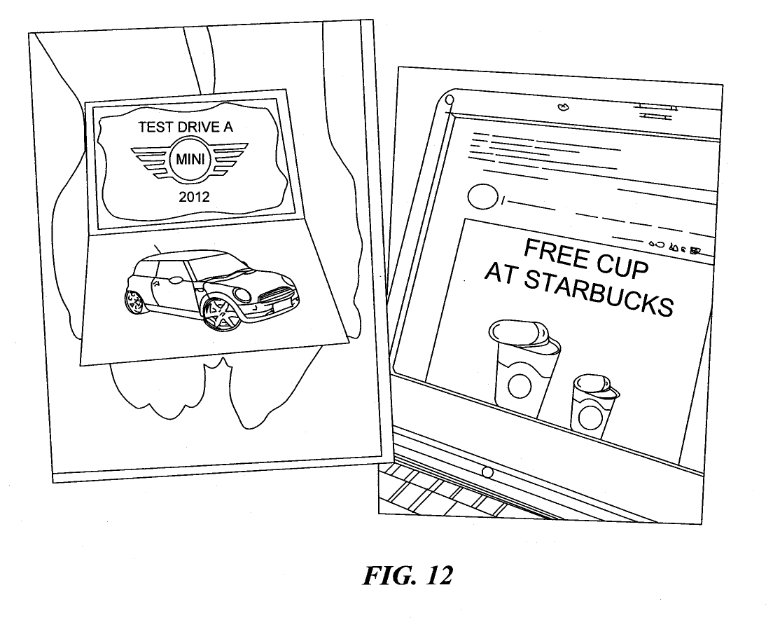

As another example of suitable post-event activity, FIG. 12 illustrates two different types of ads that may be served to participants following the event, the first being a traditional mailer, another being an email coupon. The post-event activities could be generated as a function of data mined during the event, or relate to an event sponsor. For example, perhaps during the main event, one participant chatted a message such as “I could use a Starbucks [or coffee] right now.” This might provoke a post-event email with a Starbucks' advertisement. As another example, perhaps a participant chats a message like “I love that car!” during a scene where the content layer was showing a “Mini Cooper.” Then a suitable post-event activity might be to invite the participants on a test drive of a Mini.

Events of course can be monetized in a variety of ways, by a predefined mechanism associated to a specific event, or a mechanism defined by the host participant. For example, there may be a direct charge to one or more participants, or the event may be sponsored by one or more entities. In some embodiments, the host participant directly pays the experience provider during creation or later during initiation of the event. Each participant may be required to pay a fee to participate. In some cases the fee may correspond to the level of service made available, or the level of service accessed by each participant, or the willingness of participants to receive advertisements from sponsors. For example, the event may be sponsored, and the host participant only be charged a fee if too few (or too many) participants are involved. The event might be sponsored by one specific entity, or multiple entities could sponsor various layers and/or dimensions. In some embodiments, the host participant may be able to select which entities act as sponsors, while in other embodiments the sponsors are predefined, and in yet other embodiments certain sponsors may be predefined and others selected. If the participants do not wish to see ads, then the event may be supported directly by fees to one or more of the participants, or those participants may only have access to a limited selection of layers.

As can be seen, the teaching herein provides, among other things, an interactive event platform providing enhanced sporting events, concerts, educational functions, public debates and private parties. The teaching provides various mechanisms for connecting and synchronizing multiple venues, personal and private, with multiple live events for a co-created experience.

Various implementations are contemplated. “Games” which roam from venue to venue and instantiate based on context such as computing power available locally. Specific examples include an audience applause game where applause levels at different venues affect other venues and/or a global applause feedback. In another example, the audience makes waves or lights up their devices—and again the environment reflects that moving from venue to venue.

In another embodiment, polls pop-up on individuals' devices and the users can vote in real time (such as during a lecture, conference or debate). The audience can signal their approval/disapproval or broader range of emotion—this can all go to shared screens

In another embodiment, an audience member is selected randomly to sing—application module (layer/stream) pops up—and their voice is amplified and enhanced in one example.

In another embodiment, audiences create visual effects generated by their action and by the image of the crowd, inputs from their devices' sensors

In another embodiment, venues communicate and participate interactively—e.g., ability to swap out venues to shared screens, sing together etc,

In another embodiment, the audience at a specific venue can play games during an event—simultaneously—such as creating a firework effect together, throwing snowballs at other venues, etc.

Another embodiment provides guitar-hero like games where participants co-perform with the current live action.

These various examples serve to emphasize that the system allows intake of many continuous input streams from their devices via sensors. These input streams are relatively high bandwidth and uninterrupted—such as singing or an audience making a wave. The stream processing, selecting an effect of the inputs, generating the effect and rendering it on multiple shared local and remote screens in a synchronized way are decoupled from being happening on one particular device. The system flexibility results from re-streaming and rerouting inputs and outputs.

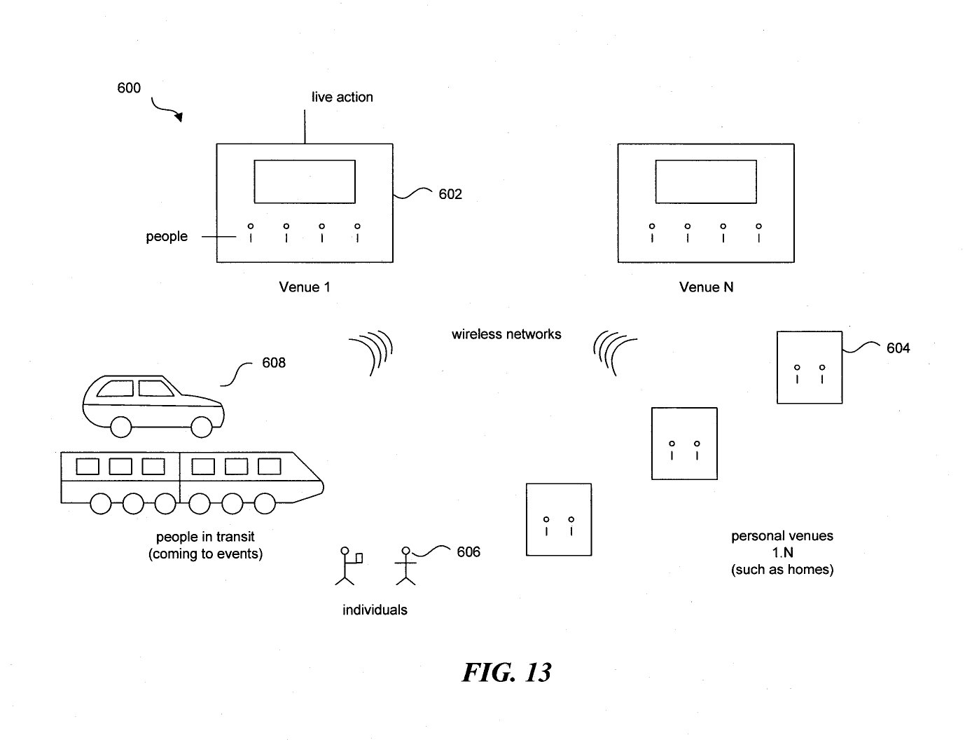

FIG. 13 provides an illustrative configuration 600 for an event according to one example that has multiple and various venues. The configuration 600 includes many different possible venues including public venues such as public venue 600, private and/or personal venues such as personal venue 604, individual venues such as 606, and even transit venues such as transit to/from event 608. Thus the invention enables multiple venues with different live events to be coupled and synchronized in a meaningful way.

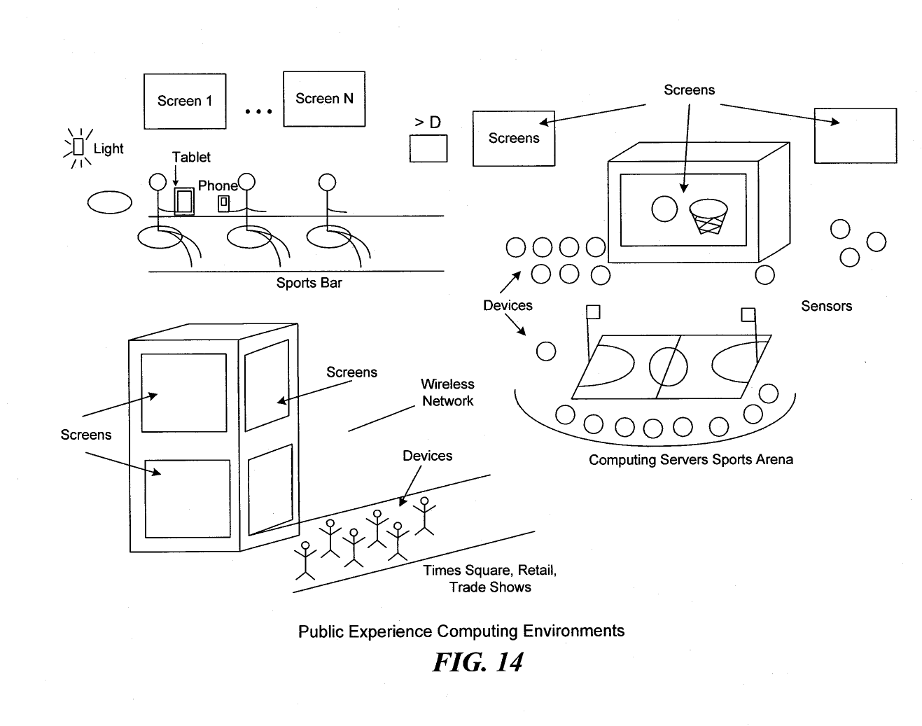

FIG. 14 illustrates an example computing environment that could be an experience computing environment in multi-screen, multi-device, multi-sensor, multi-output type of environments with many people networked and connected through a communication network (e.g., the Internet). As illustrated, multiple pluralities of screens both large and small arranged, along with a bunch of sound systems, etc. These screens and devices connected to the environment through a bunch of sensors, including, for example, temperature sensors, accelerometer, motion tracking, video recognition sensors, etc. People frequently carry their personal devices such as a phone or a media device that frequently have a variety of sensors inbuilt, including, for example, location sensors, accelerometers, gyroscopes, microphones, etc. Additionally, other devices such as personal computers have computing capabilities, including storage and processing power. Game consoles may have such capabilities as well. These devices are connected to the internet and the whole environment is wired by wired or wireless network. This allows multiple devices via multiple people to come and go and they can interact with each other using those public or private environments. Exemplary environments include sports bars, arena or stadiums, trade show setting in Times Square, etc., as illustrated in FIG. 14.

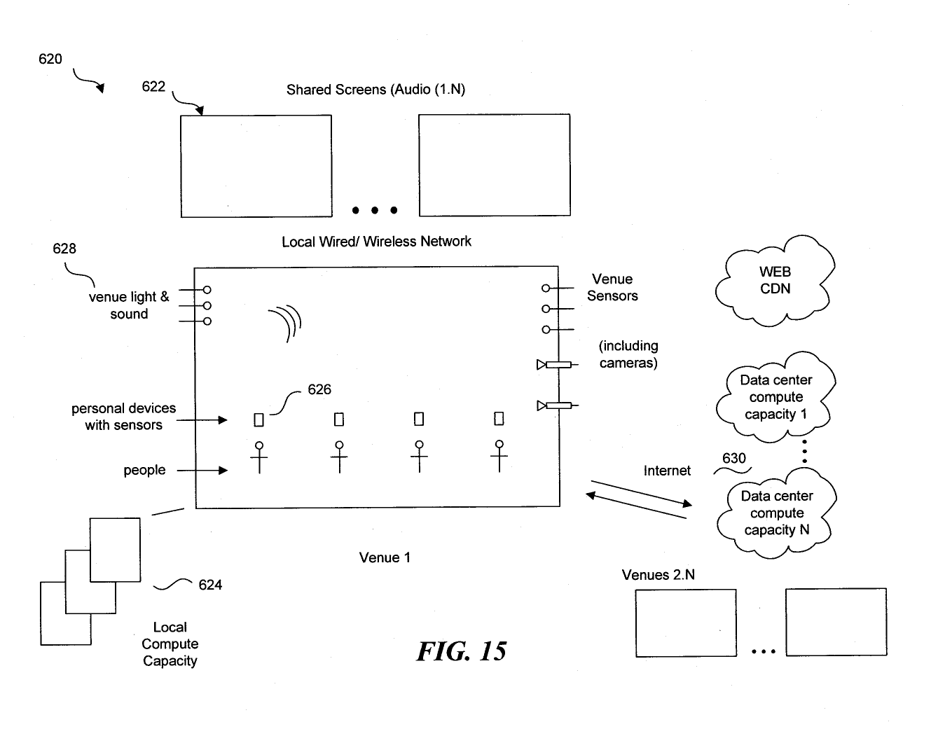

FIG. 15 provides an example venue 620 which details venue structure and architecture of the system. The venue 620 includes a plurality of public/shared screens 622, local computing capacity 624, enabled personal devices 626, and local light and sound capability 628. The local computing capacity 624 required depends on the specific implementation such as what is required to meet bandwidth limitations in connecting audiences to the internet—it is in many cases important to have this local compute capacity. The venue 620 can receive streams from standard web and content delivery network infrastructures 630—such as receiving a live broadcast from CDN from a remote location. However streams can be coming from event platform data centers, other venues or routed locally.

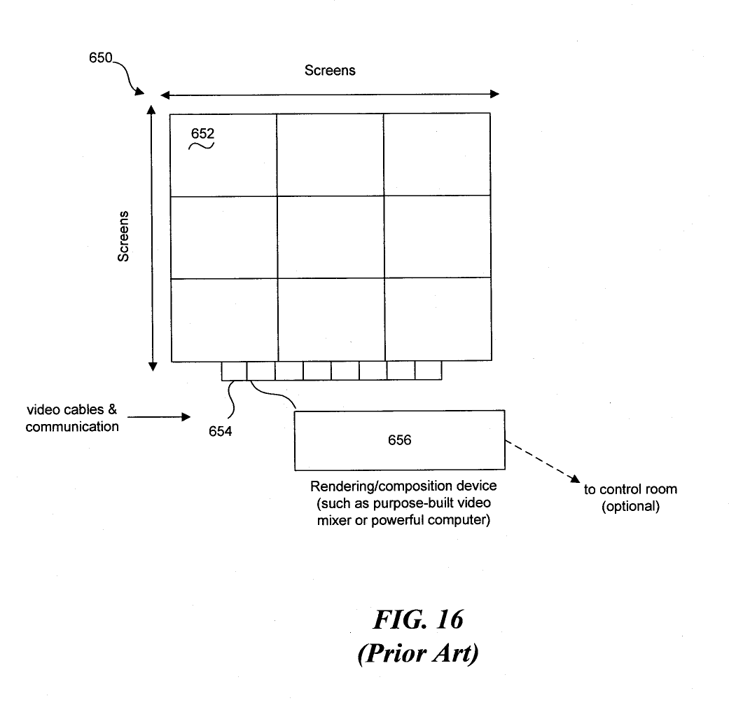

FIG. 16 illustrates a prior art architecture 650 for a large composite screen. The screen architecture 650 includes a plurality of screens 652, a plurality of communication and power connections 654, a rendering/composition device 656, and an optional control room 658. In prior art the large composite screen 650 is combined from other screens 652, via video cables and a video multiplexer, and that collection of screens and cables is connected to the rendering/composition device 656 that generates the picture (by rendering—such as a powerful computer) or composing from video streams (e.g. video mixer). The device 656 runs in a loop or controlled by a simple program, and can be affected from the control room 658. All processing is integrated as one device+no communication with audience. There is the very limited example where the audience can send a text message to jumbotron—but that's very limited

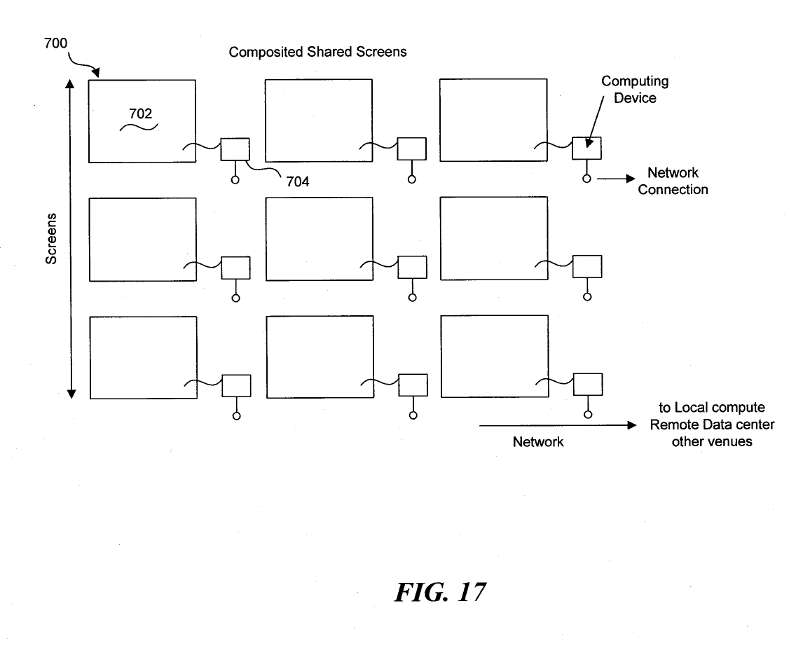

FIG. 17 illustrates composite screen architecture 700 according to one embodiment. The screen architecture 700 includes a plurality of screens 702 with each having an associated computing device 704. In the architecture 700 of FIG. 17, each screen 702 is driven by the associated separate (not-necessarily-powerful) generic device 704. The generic device 704 includes generic software component. Thus the hardware of the screens is decoupled, and each device can execute application specific modules that are transmitted as a stream or as an executable software module to expand the functionality specific to the role of that segment. All the devices 704 can be connected through generic network—such as ethernet/ip. No special communication protocol or strategy required. The system is decoupled and the audiences participate by communicating with platform event engine—on local computing capacity or in remote data centers.

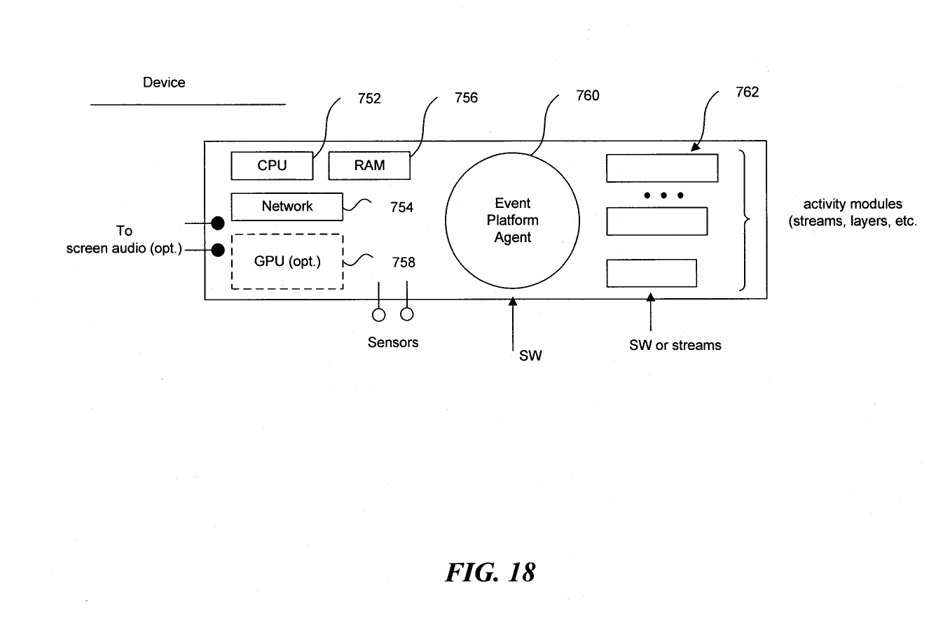

With reference to FIG. 18, a generic device 750 suitable for use as a device 704 will now be described. The device 750 includes a central processing unit (CPU) 752, network device 754, memory 756, and an option graphic processing unit (758). Instantiated on the device 750 is an event platform agent 760, generic to the event architecture. Activity modules/components 762 provide specific streams, layers, applications for implementation on the device 750.

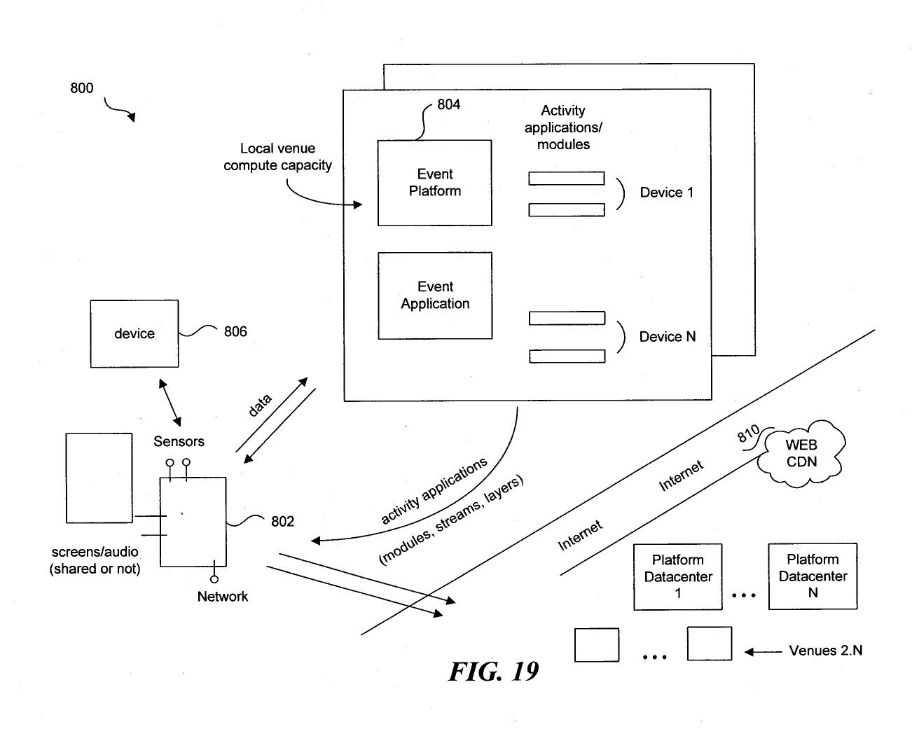

With reference to FIG. 19, architecture 800 is used to describe one possible communication scheme for coupling a device 802 within an event platform 804 and with other devices such as device 806. The device 802 communicates data from sensors and participant's actions. The device 802 can receive data streams such as video and functional modules such as executable code or as streams or as composited layers. The local devices can communicate—such as phone to phone, or phone to shared screen. As will be appreciated, layers/streams enable each device to go beyond local compute capabilities. Devices can also directly interact via internet 810 with other venues or cdns or datacenters—however they are aware of bandwidth limitations and adapt.

People in venues can be separated into groups and act together as groups—both for fun reasons (better experience, more fun—such as one group competes against another) and for scalability needs. This would mean you could only interact with people in virtual proximity to you, not with everyone simultaneously. If you want to interact with others you should “move around” and join another group. For example, in a row of people on your screen you can only talk to the person on the left or the on the right. This makes it feel like a theater plus does not bombard participants with meaningless streams. In this instance, stream routing could be handled on each device.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A computer implemented method for providing an interactive event experience, the computer implemented method comprising:
accessing computer resources at a plurality of venues;
enabling a participant to create an interactive social event spanning across the plurality of venues;
coupling and strategically synchronizing across the plurality of venues;
utilizing the computer resources, decoupling data input, data processing, output generating, and output rendering.
